(19) United States
(12) Patent Application Publication
(10) Pub. No.: US 2020/0293957 A1
(43) Pub. Date: Sep. 17, 2020

(54) WIRELESS OPERATION SYSTEM AND NON-TRANSITORY TANGIBLE COMPUTER READABLE STORAGE MEDIUM

(71) Applicant: DENSO CORPORATION, Kariya-city (JP)

(72) Inventors: Jirou HATTORI, Kariya-city (JP); Kazuki KITA, Kariya-city (JP)

(21) Appl. No.: 16/883,232

(22) Filed: May 26, 2020

Related U.S. Application Data
(63) Continuation of application No. PCT/JP2018/036683, filed on Oct. 1, 2018.

(30) Foreign Application Priority Data
Nov. 29, 2017 (JP) 2017-229420

(51) Int. Cl. G06Q 10/02; H04W 4/80; H04W 76/10; G06K 7/14; G06K 7/10

(52) U.S. Cl. CPC G06Q 10/02; H04W 4/80; G06K 7/10722; G06K 7/1417; H04W 76/10

(57) ABSTRACT

A wireless operation system includes a wireless operation terminal and an operated device operated by the wireless operation terminal. The wireless operation terminal and the operated device perform short-range communication. The wireless operation terminal and the operated device are connected to a wide area communication network and perform wide area wireless communication. The wireless operation terminal and the operated device perform transmission and reception of a signal for connection setting for the short-range communication.

### CROSS REFERENCE TO RELATED APPLICATIONS

The present application is a continuation application of International Patent Application No. PCT/JP2018/036683 filed on Oct. 1, 2018, which designated the U.S. and claims the benefit of priority from Japanese Patent Application No. 2017-229420 filed on Nov. 29, 2017. The entire disclosures of all of the above applications are incorporated herein by reference.

### TECHNICAL FIELD

The present disclosure relates to a wireless operation system and a non-transitory tangible computer readable storage medium used in a wireless operation terminal included in the wireless operation system. In particular, the present disclosure relates to a connection setting between the wireless operation terminal and an operated device operated by the wireless operation terminal.

### BACKGROUND

A wireless operation system that operates an operated device apart from a wireless operation terminal using the wireless operation terminal by performing short-range communication between the wireless operation terminal and the operated device is widely known.

### SUMMARY

The present disclosure provides a wireless operation system that includes a wireless operation terminal and an operated device operated by the wireless operation terminal. The wireless operation terminal and the operated device perform short-range communication. The wireless operation terminal and the operated device are connected to a wide area communication network and perform wide area wireless communication. The wireless operation terminal and the operated device perform transmission and reception of a signal for connection setting for the short-range communication.

### BRIEF DESCRIPTION OF DRAWINGS

The features and advantages of the present disclosure will become more apparent from the following detailed description made with reference to the accompanying drawings. In the drawings:

FIG. 1 is a diagram showing an overall configuration of a wireless operation system;

FIG. 2 is a block diagram showing a configuration of a seat air conditioner;

FIG. 3 is a block diagram showing a configuration of a smartphone;

FIG. 4 is a diagram showing information printed on a boarding reservation ticket;

FIG. 5 is a block diagram showing a configuration of a server;

FIG. 6 is a flowchart showing processing until connection setting is completed;

FIG. 7 is a flowchart showing a connection setting process;

FIG. 8 is a diagram showing a configuration of a seat air conditioner included in a wireless operation system according to a second embodiment;

FIG. 9 is a diagram showing a configuration of a server included in the wireless operation system according to the second embodiment;

FIG. 10 is a flowchart showing processing performed by the server; and

FIG. 11 is a diagram showing a configuration of a smartphone included in the wireless operation system according to the second embodiment.

### DETAILED DESCRIPTION

An exemplary wireless operation system includes a mobile terminal provided as a wireless operation terminal and an image formation device having a printer function provided as an operated device.

In order to operate the operated device with the wireless operation terminal, it is necessary to establish a wireless connection for short-range communication between the wireless operation terminal and the operated device. As a short-range communication system, various systems such as a wireless LAN system and Bluetooth (registered trademark) are known. The above described exemplary wireless operation system wirelessly communicates using an infrastructure wireless LAN. In order to establish the wireless connection in this type of communication, it is necessary to perform connection setting by mutually acquiring information for wireless connection, such as SSID (Service Set Identifier). When the user manually inputs the information, it takes a lot of time and effort, and an input error may occur.

In the above described exemplary wireless operation system, the wireless operation terminal can acquire the information necessary for the connection setting by reading the two-dimensional code. After acquiring the information, the wireless operation terminal performs short-range communication and performs the connection setting with the operated device via the access point.

In the above described exemplary wireless operation system, when performing the connection setting for communication between the wireless operation terminal and the operated device, the wireless operation terminal and the operated device perform short-range communication, and exchange an information necessary for connection setting with each other.

Once the connection setting is made, thereafter, the establishment of the wireless connection can be switched by changing the on/off setting of the wireless connection. When the setting is made to establish the wireless connection, the wireless connection is automatically established when the radio wave is reached between the wireless operation terminal and the operated device.

Therefore, in order to establish the wireless connection between the wireless operation terminal and the operated device in a case where they are apart from each other and are incapable of performing the short-range communication, there is a demand that the setting should be made in advance. When the connection setting is made in advance, it is possible to operate the operated device by the wireless operation terminal from the time when the wireless operation terminal approaches the operated device. However, conventionally, when the wireless operation terminal and the operated device are separated from each other by a distance in which short-range communication cannot be performed, connection setting cannot be performed.

The present disclosure provides a wireless operation system in which a connection setting for short-range communication can be set at a remote position where a wireless operation terminal and an operated device cannot perform short-range communication. The present disclosure also provides a non-transitory tangible computer readable storage medium used in the wireless operation terminal.

An exemplary embodiment of the present disclosure provides a wireless operation system that includes a wireless operation terminal and an operated device operated by the wireless operation terminal. The wireless operation terminal and the operated device perform short-range communication. The wireless operation terminal include an acquisition unit, an operation terminal-side wide area communication unit, and an operation terminal-side connection setting unit. The acquisition unit acquires operated device identification information which is information for identifying the operated device as a communication partner for the short-range communication from a medium apart from the operated device. The operation terminal-side wide area communication unit is connected to a wide area communication network and performs wide area wireless communication. The operation terminal-side connection setting unit (i) identifies the operated device to be the communication partner based on the operated device identification information, (ii) causes the operation terminal-side wide area communication unit to transmit, to the operated device, operation terminal identification information which is information for the operated device to communicate with the wireless operation terminal, and (iii) performs transmission and reception of a signal for connection setting for the short-range communication with the operated device via the operation terminal-side wide area communication unit. The operated device includes an operated device-side wide area communication unit and an operated device-side connection setting unit. The operated device-side wide area communication unit is connected to the wide area communication network and performs the wide area wireless communication. The operated device-side connection setting unit (i) receives the operation terminal identification information transmitted from the wireless operation terminal via the operated device-side wide area communication unit and (ii) performs transmission and reception of the signal for the connection setting for the short-range communication with the wireless operation terminal via the operated device-side wide area communication unit.

In the exemplary embodiment of the present disclosure, each of the wireless operation terminal and the operated device includes a wide area communication unit. The wide area communication unit performs the connection setting for the short-range communication. Therefore, the connection setting for the short-range communication can be performed at a remote position where the wireless operation terminal and the operated device cannot perform the short-range communication.

Another exemplary embodiment of the present disclosure provides a wireless operation system that includes a wireless operation terminal and an operated device operated by the wireless operation terminal. The wireless operation terminal identifies the operated device as a communication partner for performing short-range communication with the operated device. The operated device identifies the wireless operation terminal as a communication partner for performing the short-range communication with the wireless operation terminal. The wireless operation terminal and the operated device share an encryption key and perform transmission and reception of a signal encrypted with the encryption key. The wireless operation system further includes a storage medium existing apart from the operated device and configured to store operated device identification information and the encryption key in association with each other. The operated device identification information identifies, as the communication partner, each of a plurality of operated target devices that includes the operated device. The encryption key is used when the operated device identified by the operated device identification information performs the short-range communication. The wireless operation terminal includes a connection setting unit configured to (i) acquire the encryption key corresponding to the operated device identification information from the storage medium by identifying the operated device identification information and (ii) perform connection setting for the short-range communication based on the acquired encryption key.

In the other exemplary embodiment of the present disclosure, the storage medium stores the operated device identification information and the encryption key used by the operated device specified by the operated device identification information for performing the short-range communication in association with each other. Therefore, the wireless operation terminal can perform the connection setting for the short-range communication by acquiring the encryption key from the storage medium. Since the storage medium exists apart from the operated device, the connection setting for the short-range communication can be performed even at a remote position where the wireless operation terminal and the operated device cannot perform the short-range communication.

Another exemplary embodiment of the present disclosure provides a non-transitory tangible computer readable storage medium that includes instructions executed by a processor of a wireless operation terminal configured to perform short-range communication with an operated device and operate the operated device. The instructions comprising: acquiring operated device identification information which is information for identifying the operated device as a communication partner for the short-range communication from a medium apart from the operated device; performing wide area wireless communication by connecting a wide area communication network; identifying the operated device to be the communication partner based on the operated device identification information; transmitting, to the operated device, operation terminal identification information which is information for the operated device to communicate with the wireless operation terminal; and performing transmission and reception of a signal for connection setting for the short-range communication with the operated device.

Another exemplary embodiment of the present disclosure provides a non-transitory tangible computer readable storage medium that includes instructions executed by a processor of a wireless operation terminal configured to perform short-range communication with an operated device and operate the operated device. The instructions includes: acquiring an encryption key corresponding to operated device identification information from a storage medium by identifying the operated device identification information; and performing connection setting for short-range communication based on the acquired encryption key. The storage medium exists apart from the operated device and stores the operated device identification information and the encryption key in association with each other. The operated device identification information identifies, as the communication partner, each of a plurality of operated target devices that includes the operated device. The encryption key is used when the operated device identified by the operated device identification information performs the short-range communication.

### First Embodiment

(General configuration)

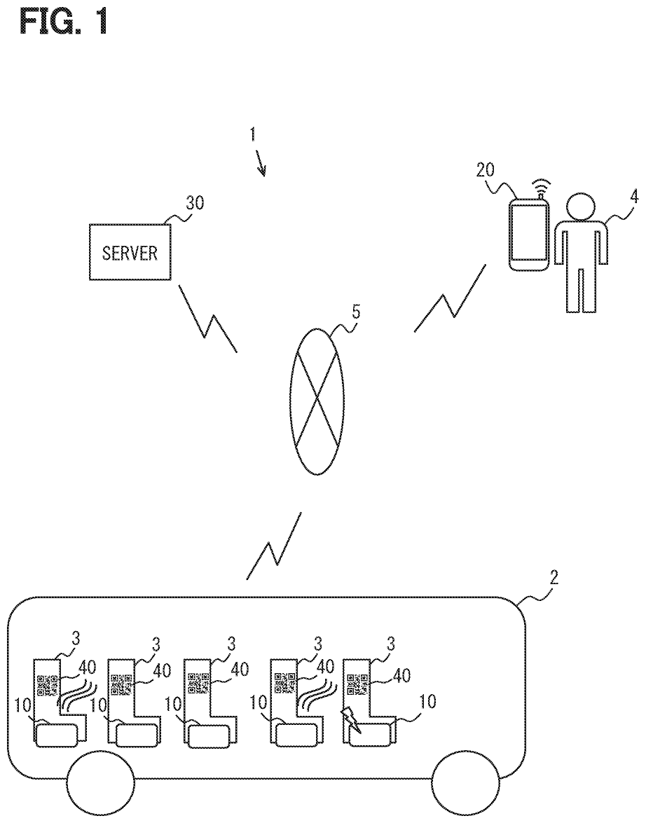

FIG. 1 is a diagram showing an overall configuration of a wireless operation system 1. A schematic configuration of the wireless operation system 1 will be described with reference to FIG. 1. The wireless operation system 1 includes a seat air conditioner 10 provided as an operated device, a smartphone 20 provided as a wireless operation terminal, and a server 30. The operated device is also referred to as an operated target device.

The seat air conditioner 10 is installed on each of a plurality of seats 3 provided on a bus 2. The bus 2 of the present embodiment is a bus in which seat reservations can be made. The seat air conditioner 10 is installed at the lower part of the seat 3. The seat air conditioner 10 air-conditions the seat 3 and the vicinity thereof. The seat air conditioner 10 is capable of being operated by the smartphone 20.

A two-dimensional code 40 is shown on the seat 3. The two-dimensional code 40 stores a seat number and a BD address required for the smartphone 20 to make a connection setting for short-range communication with the seat air conditioner 10. In the present embodiment, the short-range communication is specifically communication according to the Bluetooth standard (hereinafter, Bluetooth communication), and the connection setting is called as pairing. In order to show the two-dimensional code 40 on the seat 3, for example, the two-dimensional code 40 is printed on a seat cover attached to the seat 3. Further, the two-dimensional code 40 also stores a command for causing the smartphone 20 to display an operation screen for operating the seat air conditioner 10.

The smartphone 20 is carried by the user 4. The smartphone 20 has a Bluetooth communication function and a wide area communication function, and pairing can be performed in both the Bluetooth communication and the wide area communication. The processing for pairing will be described later. Further, after pairing is established, the seat air conditioner 10 is capable of being remotely operated.

The server 30 is capable of communicating with the smartphone 20 and the seat air conditioner 10 via a wide area communication network 5. The server 30 manages the reservation status of the seat 3 of the bus 2. Further, the server 30 determines whether pairing using the wide area communication between the smartphone 20 and the seat air conditioner 10 is permitted.

(Configuration of Seat Air Conditioner 10)

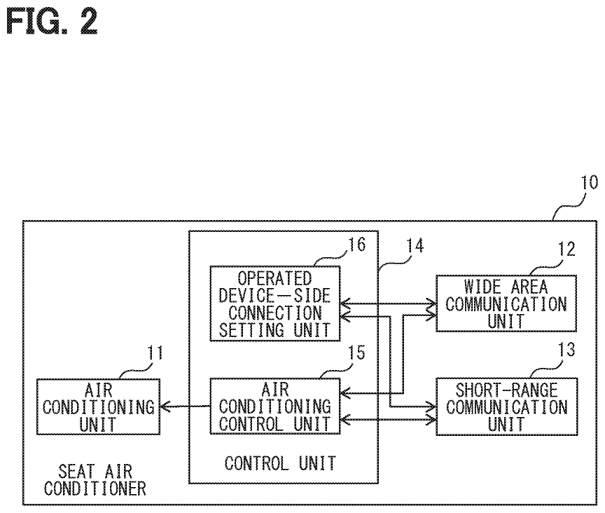

As shown in FIG. 2, the seat air conditioner 10 includes an air conditioning unit 11, a wide area communication unit 12, a short-range communication unit 13, and a control unit 14.

The air conditioning unit 11 is a mechanical structure that blows out air to adjust temperature or humidity around the seat 3 in which the seat air conditioner 10 is installed. The wide area communication unit 12 is a communication unit that performs the wide area communication which is wireless communication via the wide area communication network 5, and is capable of performing both transmission and reception as communication. The wide area communication unit 12 corresponds to an operated device-side wide area communication unit.

The short-range communication unit 13 is a communication unit that is capable of directly performing the short-range communication with another communication device that is capable of performing the short-range wireless communication. As described above, the short-range communication is provided by Bluetooth communication in this embodiment.

The control unit 14 is a computer including a CPU, a ROM, a RAM, an I/O, and a bus line for connecting these components. The ROM stores a program for causing a general-purpose computer to function as the control unit 14. When the CPU executes the program stored in the ROM while using the temporary storage function of the RAM, the control unit 14 functions as an air conditioning control unit 15 and an operated device-side connection setting unit 16. When the above-described functions are executed, a method corresponding to the program is executed.

It should be noted that a storage medium for storing the program executed by the CPU is not limited to the ROM but may be stored in a non-transitory tangible storage medium. For example, the program may be stored in a flash memory. In addition, part or all of the functions of the control unit 14 may be realized by using one or more ICs (in other words, as hardware). In addition, a part or all of the functions of the control unit 14 may be realized by a combination of software execution by the CPU and hardware components.

The air conditioning control unit 15 operates the air conditioning unit 11 with the setting determined by the setting operation of the user 4. The setting operation of the user 4 is performed via the paired smartphone 20, and the command signal determined by the setting operation is transmitted from the smartphone 20 to the seat air conditioner 10. The smartphone 20 is capable of transmitting this command signal by both wide area communication and Bluetooth communication. In the seat air conditioner 10, when the command signal is transmitted by the wide area communication, the wide area communication unit 12 receives the command signal, and when the command signal is transmitted by the Bluetooth communication, the short-range communication unit 13 receives the command signal. When the command signal is acquired from the wide area communication unit 12 or the short-range communication unit 13, the air conditioning control unit 15 controls the air conditioning unit 11 in response to the command signal.

The operated device-side connection setting unit 16 generates a signal for performing pairing, and perform the transmission and reception of the signal with the smartphone 20. The communication at this time can be performed either wide area communication or Bluetooth communication. Since the processing for pairing is also related to the processing of the smartphone 20 and the server 30, the processing for pairing will be described after the configurations of the smartphone 20 and the server 30 are described.

(Configuration of Smartphone 20)

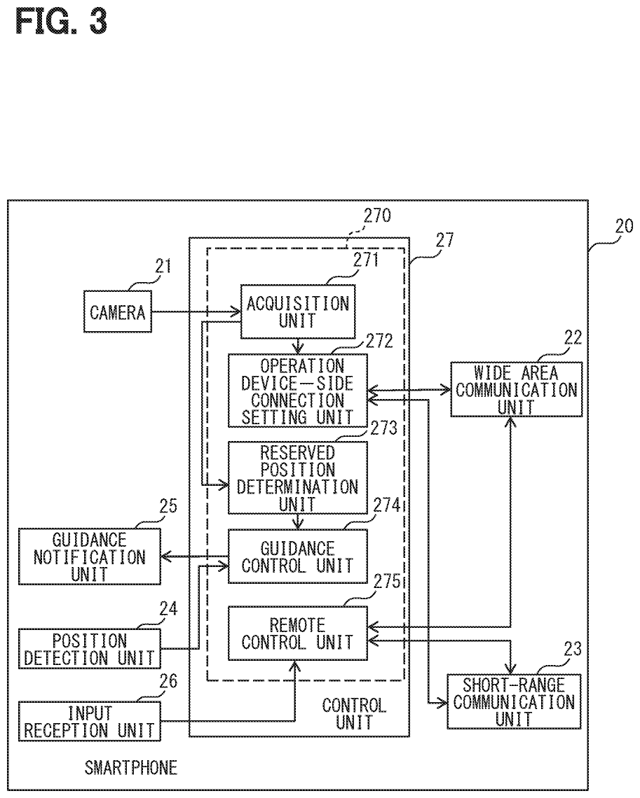

As shown in FIG. 3, the smartphone 20 includes a camera 21, a wide area communication unit 22, a short-range communication unit 23, a position detection unit 24, a guidance notification unit 25, an input reception unit 26, and a control unit 27.

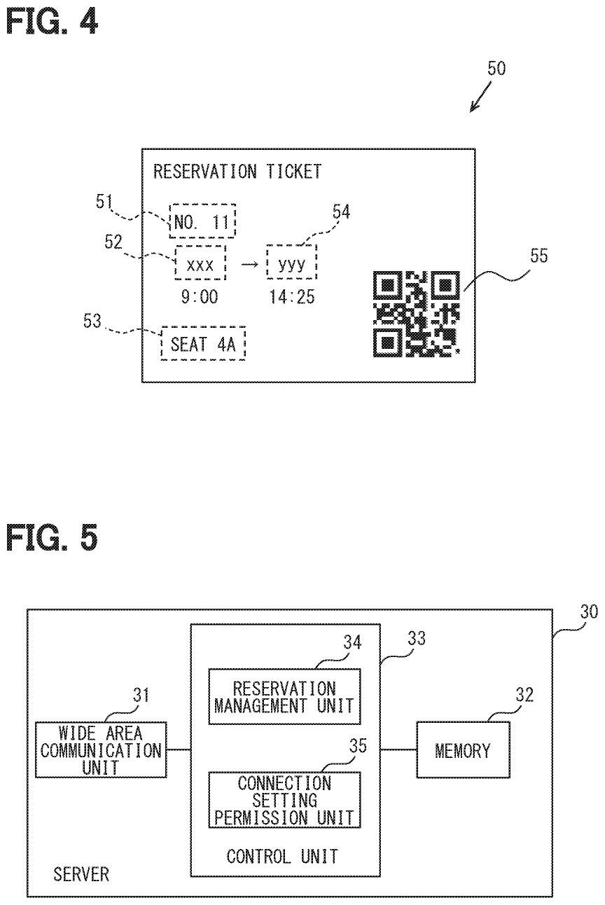

In the present embodiment, the camera 21 is used to capture an image including a two-dimensional code 55 shown in FIG. 4. The wide area communication unit 22 is a communication unit that performs the wide area wireless communication. The wide area communication unit 22 is capable of performing both transmission and reception, and performing the wide area communication with the seat air conditioner 10 and the server 30. The wide area communication unit 22 corresponds to an operation terminal-side wide area communication unit. The short-range communication unit 23 is a communication unit capable of performing the Bluetooth communication which is short-range communication. As the short-range communication, communication according to the Wi-Fi (registered trademark) communication standard is also available.

The position detection unit 24 sequentially detects a current position of the smartphone 20. In order to detect the current position, the position detection unit 24 includes a GNSS (Global Navigation Satellite System) receiver that receives a navigation signal transmitted by a navigation satellite included in a GNSS. The position detection unit 24 sequentially detects the current position based on the navigation signal received by this GNSS receiver.

The guidance notification unit 25 outputs a guidance notification. This guidance notification is a notification for guiding the user 4 to the reserved seat 3. The guidance notification unit 25 is specifically one or both of a display and a speaker. By reading the bus number 51, the boarding bus stop 52, and the reserved seat number 53 of the bus 2 shown in the boarding reservation ticket 50 (see FIG. 4), the position of the reserved seat 3 can be determined. The content of the guidance notification is determined based on the position of the reserved seat 3 and the current position.

On the boarding reservation ticket 50 shown in FIG. 4, a getting-off bus stop 54 and the two-dimensional code 55 are also printed. This boarding reservation ticket 50 can be issued when the user 4 accesses the server 30 using the smartphone 20 and inputs the bus number, the boarding bus stop, the getting-off bus stop, the reservation seat, or the like of the bus 2 to be reserved.

After the reservation is made, the boarding reservation ticket 50 is printed by the printer and the issue of the boarding reservation ticket 50 is completed. Instead of using the smartphone 20, a dedicated reservation machine installed in a station or a personal computer may be used as an input terminal to access the server 30.

The two-dimensional code 55 stores the bus number 51, the boarding bus stop 52, the reserved seat number 53, and the getting-off bus stop 54 of the bus 2. The bus number 51 and the reserved seat number 53 of the bus 2 are included in a seat air conditioner identification information required for the user 4 to identify the seat air conditioner 10. When there is a stop between the departure point and the end point and the reserved person changes at the stop on the way, the bus numbers are the same. In this case, the seat air conditioner identification information also includes the boarding bus stop 52 or the boarding bus stop 52 and the getting-off bus stop 54. When the seat air conditioner identification information is determined, the section in which the user 4 who reserved the seat 3 uses the seat 3 is determined by referring to the operation schedule data of the bus 2. Therefore, the seat air conditioner 10 provided on the seat 3 and the section in which the seat air conditioner 10 is used can be identified. The operation schedule data is data indicating when and where the bus 2 is scheduled to travel. Since the seat air conditioner 10 is the operated device, the seat air conditioner identification information corresponds to an operated device identification information.

Further, the two-dimensional code 55 also stores a command for instructing the smartphone 20 to display an operation screen for operating the seat air conditioner 10.

The input reception unit 26 may be provided by a touch panel. The input reception unit 26 receives various setting inputs when the user 4 remotely operates the seat air conditioner 10.

The control unit 27 is a computer including a CPU, a ROM, a RAM, an I/O, and a bus line for connecting these components. The ROM stores a wireless operation program 270 for causing a general-purpose computer to function as the control unit 27. When the CPU executes the wireless operation program 270 stored in the ROM while using the temporary storage function of the RAM, the control unit 27 functions as an acquisition unit 271, an operation terminal-side connection setting unit 272, a reserved position determination unit 273, a guidance control unit 274, and a remote control unit 275. When the above-described functions are executed, a method corresponding to the wireless operation program 270 is executed.

The acquisition unit 271 analyzes the image captured by the user 4 with the camera 21 and determines the presence or absence of the two-dimensional code 55. When the acquisition unit 271 determines that the two-dimensional code 55 is captured, the information stored in the two-dimensional code 55 is read. As a result, the acquisition unit 271 acquires the seat air conditioner identification information from the boarding ticket 50, which is a paper medium in which the seat air conditioner identification information is printed.

The operation terminal-side connection setting unit 272 transmits the seat air conditioner identification information acquired by the acquisition unit 271 to the server 30. The server 30 determines to permit smartphone 20 to perform pairing with the seat air conditioner 10 when the seat 3 that can be identified from the seat air conditioner identification information satisfies pairing permission condition including that the seat 3 is not currently reserved by another customer. When the server 30 determines that pairing is permitted, the server 30 transmits the address of the wide area communication unit 12 of the seat air conditioner 10 identified by the seat air conditioner identification information (hereinafter, wide area communication address) and the BD address to the smartphone 20.

When the wide area communication address and the BD address of the seat air conditioner 10 are acquired from the server 30, the operation terminal-side connection setting unit 272 transmits an operation terminal identification information to the seat air conditioner 10. The operation terminal identification information is information for the seat air conditioner 10 to communicate with the smartphone 20. Specifically, the operation terminal identification information is provided by the wide area communication address of the wide area communication unit 22 and the BD address of the short-range communication unit 23 of the smartphone 20. When the operation terminal identification information is received by the seat air conditioner 10, the communication partners can be mutually identified. Thereafter, signals are transmitted and received according to the procedure defined in the Bluetooth standard, and pairing, which is a connection setting, is performed.

The operation terminal identification information is transmitted from the wide area communication unit 22 or the short-range communication unit 23. Whether to transmit the operation terminal identification information from the wide area communication unit 22 or the short-range communication unit 23 depends on whether to communication with the seat air conditioner 10 can be performed by Bluetooth communication. When it is possible to communicate with the seat air conditioner 10 by Bluetooth communication, the operation terminal identification information is transmitted from the short-range communication unit 23. At this time, the BD address is used. When the Bluetooth communication is incapable of being performed, the wide area communication unit 22 transmits the operation terminal identification information. At this time, the wide area communication address is used.

The reservation position determination unit 273 acquires the bus number 51 and the reserved seat number 53 of the bus 2 from the acquisition unit 271. Further, the correspondence data of the seat arrangement and the seat number in the bus 2 is acquired. This correspondence data may be stored in advance in a storage medium included in the smartphone 20 or may be acquired from the outside by communication. The position of the reserved seat 3 in the bus 2 is determined from the correspondence data and the reserved seat number 53.

The guidance control unit 274 performs guidance control for guiding the user 4 who has the smartphone 20 to the position determined by the reserved position determination unit 273. Specifically, the current position is sequentially acquired from the position detection unit 24. From the current position and the position of the boarding bus stop 52, the guidance notification unit 25 outputs a notification for guiding the user 4 to the boarding bus stop 52. Note that this control is executed when the guidance start operation is performed by the user 4. Further, when it is determined that the current position of the user 4 is inside the bus 2 or in the vicinity of the bus 2, the guidance control unit 274 causes guidance the notification unit 25 to give a notification for guiding the user 4 to the reserved seat 3. The notification for guiding the user 4 to the reserved seat 3 may include displaying a seat layout diagram showing the position of the reserved seat 3 in the bus 2. The notification may show the traveling direction to reach the reserved seat 3.

After pairing is performed, the remote control unit 275 transmits a command signal for remotely operating the seat air conditioner 10 to the seat air conditioner 10. The command signal is determined by the operation of the input reception unit 26 by the user 4. Further, as described above, the two-dimensional code 40, 55 stores the command for instructing the smartphone 20 to display the operation screen for operating the seat air conditioner 10. Therefore, when the two-dimensional code 40, 55 is captured, the operation screen for operating the seat air conditioner 10 is displayed on the display of the smartphone 20. The user 4 is capable of determining the command signal by operating this operation screen.

(Configuration of Server 30)

As shown in FIG. 5, the server 30 includes a wide area communication unit 31, a memory 32, and a control unit 33. The wide area communication unit 31 is provided as a communication unit that performs wide area communication. The memory 32 is provided as an electromagnetic storage medium that electrically or magnetically stores information.

The memory 32 is, for example, a flash memory. The memory 32 stores the reservation status of each seat 3 for the multiple buses 2 managed by the server 30. The reservation status indicates the reserved boarding section for the bus number of each bus 2. Further, the memory 32 stores the correspondence between each seat 3 of the bus 2 and the seat air conditioner 10 installed on the seat 3. The memory 32 also stores a wide area communication address and a BD address of each seat air conditioner 10.

The control unit 33 is a computer including a CPU, a ROM, a RAM, an I/O, and a bus line for connecting these components. The ROM stores a program for causing a general-purpose computer to function as the control unit 33. When the CPU executes the program stored in the ROM while using the temporary storage function of the RAM, the control unit 33 functions as a reservation management unit 34 and a connection setting permission unit 35. When the above-described functions are executed, a method corresponding to the program is executed.

The reservation management unit 34 sequentially updates the reservation status stored in the memory 32. The reservation status is updated by connecting to the smartphone 20 or another terminal having a reservation function.

When receiving the seat air conditioner identification information from the smartphone 20, the connection setting permission unit 35 determines whether to permit the smartphone 20 to perform pairing with the seat air conditioner 10. In this determination, first, the seat air conditioner 10 that is a communication partner is identified based on the seat air conditioner identification information. Further, the server 30 determines whether pairing permission condition is satisfied. The pairing permission condition includes a condition that the seat 3 in which the identified seat air conditioner 10 is installed is not currently reserved by another customer, and the present time is after the fixed time prior to the boarding time identified by the seat air conditioner identification information. The fixed time is, for example, 30 minutes. When the server 30 determines that pairing permission condition is satisfied, the smartphone 20 is permitted to perform pairing with the seat air conditioner 10. When the server 30 determines that pairing is permitted, the server 30 transmits the wide area communication address of the seat air conditioner 10 and the BD address identified by the seat air conditioner identification information to the smartphone 20.

(Flow of Pairing Using Wide Area Communication)

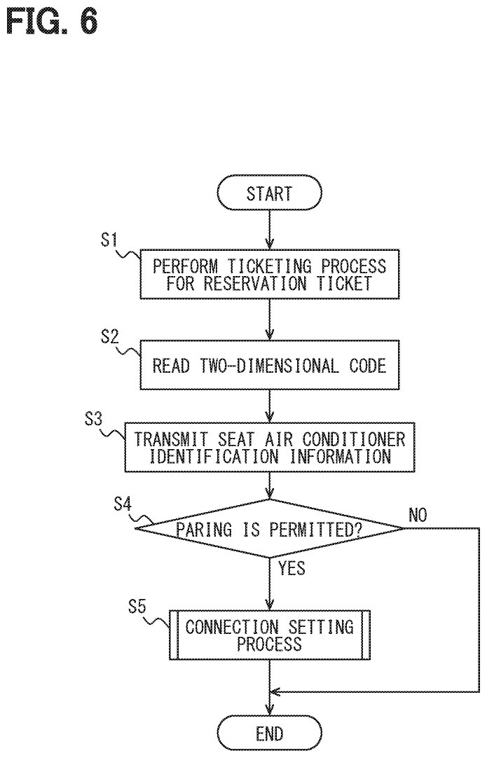

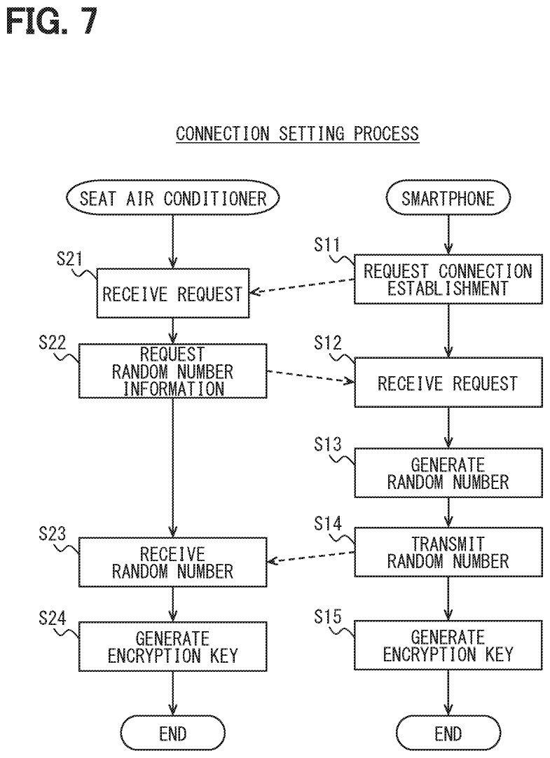

A pairing flow using the wide area communication will be described with reference to FIGS. 6 and 7. As shown in FIG. 6, in S1, a ticketing process of the boarding reservation ticket 50 is performed. As described above, this process is performed by connecting to the server 30 from the smartphone 20, the dedicated reservation machine, the personal computer, or the like.

The acquisition unit 271 of the smartphone 20 performs the process of S2. In S2, the boarding reservation ticket 50 acquired in S1 is captured by the camera 21, and the seat air conditioner identification information stored in the two-dimensional code 55 is read by starting the application for reading the boarding reservation ticket 50.

In S3, the seat air conditioner identification information read in S2 is transmitted to the server 30. This process is executed by the operation terminal-side connection setting unit 272, and is executed when the user 4 performs the transmission instruction operation.

In S4, it is determined whether pairing is permitted. The operation terminal-side connection setting unit 272 also executes the process of S4. When the determination result at S4 is NO, the processing does not proceed to S5. When the determination result at S4 is YES, the processing proceeds to S5. When pairing is permitted, the operation terminal-side connection setting unit 272 acquires the wide area communication address and the BD address of the seat air conditioner 10 from the server 30. In S5, connection setting process is performed.

The process of S5 is shown in detail in FIG. 7. In the connection setting process shown in FIG. 7, the smartphone 20 and the seat air conditioner 10 communicate with each other. This communication is wide area communication. The connection setting process shown in FIG. 7 is similar to the process defined in the Bluetooth standard, except that the communication is wide area communication. The process in the smartphone 20 is executed by the operation terminal-side connection setting unit 272, and the process in the seat air conditioner 10 is executed by the operated device-side connection setting unit 16.

In S11, a connection establishment request is transmitted to the seat air conditioner 10. Since the wide area communication address of the seat air conditioner 10 is acquired at the time of executing the connection setting process, the connection establishment request can be transmitted to the seat air conditioner 10. The connection establishment request includes the wide area communication address of the smartphone 20 and the authentication code. The authentication code is specifically a PIN code or a passkey.

The seat air conditioner 10 receives this connection establishment request in S21. In S22, a signal for requesting a random number information for generating the encryption key is transmitted to the smartphone 20. The smartphone 20 receives the request in S12. In S13, a random number is generated by a predetermined function or the like. In S14, the random number generated in S13 is transmitted to the seat air conditioner 10. In S15, an encryption key is generated based on the authentication code transmitted in S11, the random number transmitted in S14, and the encryption generation algorithm.

The seat air conditioner 10 receives the random number transmitted from the smartphone 20 in S23. In S24, the encryption key is generated based on the random number received in S23, the authentication code received in S21, and the encryption generation algorithm. The encryption generation algorithm used here is a common algorithm to the encryption generation algorithm used in the smartphone 20.

Pairing is completed by the above-described processing, and thereafter, in Bluetooth communication between the smartphone 20 and the seat air conditioner 10, a signal encrypted using this encryption key is transmitted and received.

With the above-described processing, pairing for Bluetooth communication using wide area communication is completed. As a result, the smartphone 20 carried by the user 4 is in pairing between the seat air conditioner 10 from the time when the user 4 gets on the bus 2 without performing the pairing operation after getting on the bus 2.

Therefore, the user 4 can save time for finding out the BD address of the seat air conditioner 10 installed on the seat 3 on which the user 4 sits from the list in which the BD addresses of a large number of seat air conditioners 10 are displayed, and performing an operation for pairing after boarding.

Further, in the present embodiment, the processing for pairing does not start at the time of reservation, but the processing for pairing starts by reading the two-dimensional code 55 printed on the boarding reservation ticket 50. Therefore, the smartphone 20 used for the reservation of the seat 3 and the smartphone 20 that performs pairing can be separated. Therefore, for example, for an elderly person who is unfamiliar with the processing for booking, another person can make a reservation for the seat 3. In this case, when the elderly person receives the boarding reservation ticket 50, pairing can be performed by the smartphone 20 owned by the elderly person.

Further, in the present embodiment, even when pairing by the wide area communication cannot be performed in advance, pairing can be performed by capturing the two-dimensional code 40 shown on the seat 3 using the camera 21. Even in this case, it is possible to save the time for finding out the BD address of the seat air conditioner 10 installed on the seat 3 on which the user 4 sits from the list in which the BD addresses of a large number of seat air conditioners 10 are displayed.

The smartphone 20 can also operate the seat air conditioner 10 through the wide area communication after pairing by the wide area communication is completed. Therefore, the user 4 can cool or warm the vicinity of the reserved seat 3 before getting on the bus 2.

In addition, since the smartphone 20 includes the guidance control unit 274 that guides the user 4 to the reserved seat 3 of the bus 2, the user 4 can easily reach the reserved seat 3.

Further, when the two-dimensional code 40, 55 is captured, the operation screen of the seat air conditioner 10 is displayed. Thus, the operation of the seat air conditioner 10 can be easily performed.

### Second Embodiment

Next, a second embodiment will be described. In the description of the second and subsequent embodiments, elements having the same reference numerals as those used so far are identical to the elements having the same reference numerals in the previous embodiment(s), unless otherwise specified. When only a part of the configuration is described, the embodiment described above can be applied to other parts of the configuration.

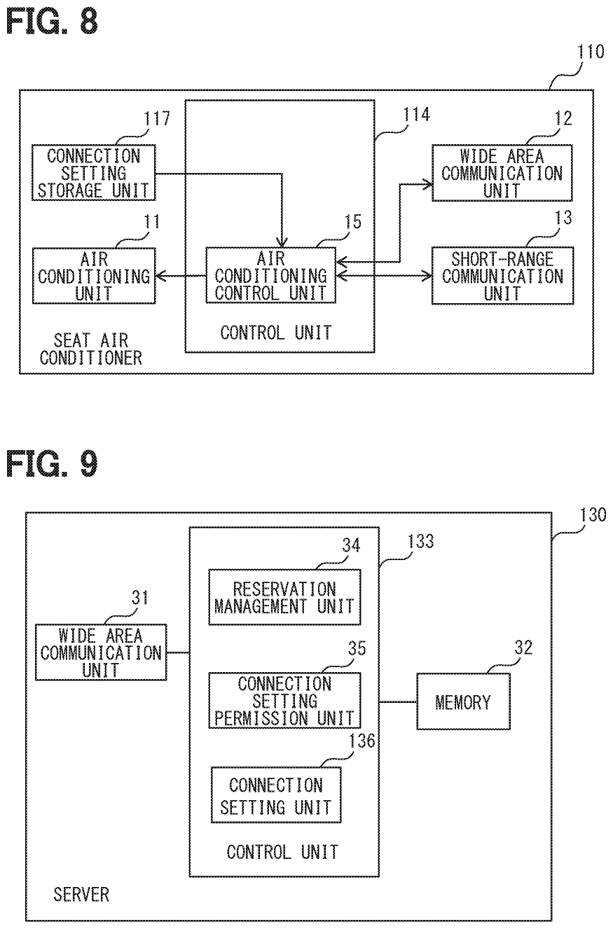

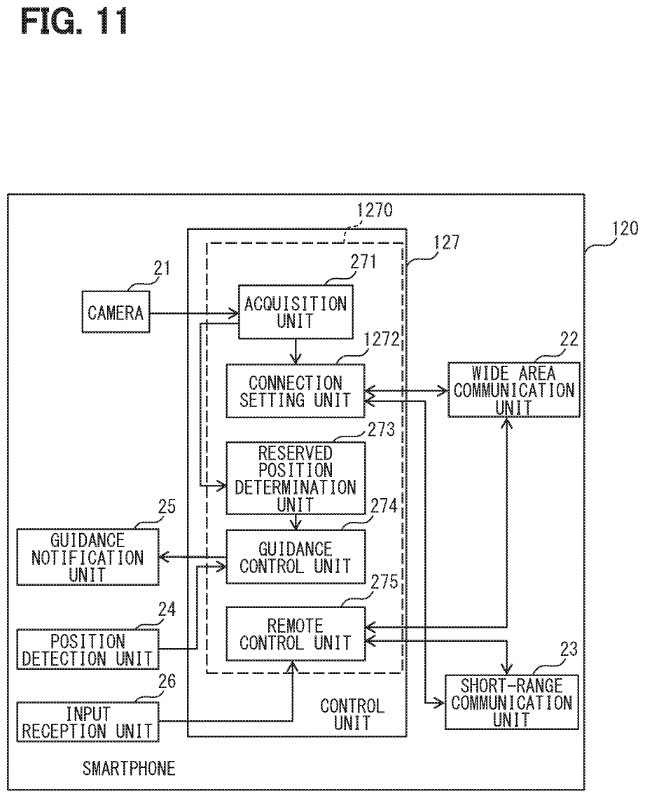

The wireless operation system of the second embodiment includes a seat air conditioner 110 shown in FIG. 8, a server 130 shown in FIG. 9, and a smartphone 120 shown in FIG. 11, respectively corresponding to, the seat air conditioner 10, the server 30, the smartphone 20 of the first embodiment.

The seat air conditioner 110 of the second embodiment has the configuration shown in FIG. 8. The control unit 114 of the seat air conditioner 110 does not include the operated device-side connection setting unit 16 included in the control unit 14 of the seat air conditioner 10. Instead of the operated device-side connection setting unit 16, the seat air conditioner 110 includes a connection setting storage unit 117.

The connection setting storage unit 117 stores an encryption key assigned to the seat air conditioner 10. This encryption key is used instead of the encryption key generated in S24.

In the server 130 of the second embodiment, as shown in FIG. 9, the control unit 133 includes a connection setting unit 136. Further, in addition to the same information as in the first embodiment, the memory 32 stores, for each seat air conditioner 10, the seat air conditioner identification information, the encryption key stored in the connection setting storage unit 117 of the seat air conditioner 10, and the BD address of the seat air conditioner 10. The memory 32 is an electromagnetic storage medium and exists apart from the seat air conditioner 10.

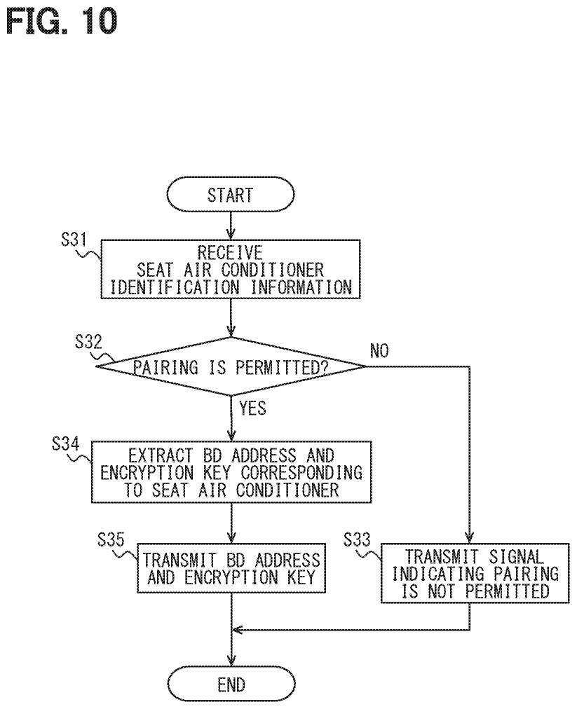

The connection setting unit 136 performs the connection setting between the seat air conditioner 110 and the smartphone 120 instead of the seat air conditioner 110. The connection setting processing performed by the connection setting unit 136 will be described with reference to FIG. 10.

In FIG. 10, S31, S32, and S33 are processes executed by the connection setting permission unit 35, and S34 and S35 are processes executed by the connection setting unit 136.

In S31, the seat air conditioner identification information is received from the smartphone 120. The smartphone 120 of the second embodiment also executes the processing shown in FIG. 6. The connection setting process executed in S5 in FIG. 6 is different from that in the first embodiment. The connection setting processing in the second embodiment will be described later. When the smartphone 120 executes S3 of FIG. 6, the server 130 can receive the seat air conditioner identification information in S31.

In S32, it is determined whether the smartphone 120 is permitted to perform pairing with the seat air conditioner 10. The specific determination method has already been described in the first embodiment, so description thereof will be omitted here. If the determination in S32 is NO, the process proceeds to S33. In S33, a signal indicating that pairing is not permitted is transmitted to the smartphone 120. When the determination of S32 is YES, the process proceeds to S34.

In S34, the BD address and the encryption key corresponding to the seat air conditioner 10 identified by the seat air conditioner identification information received in S31 are extracted from the memory 32. In S35, the BD address and the encryption key extracted in S34 are transmitted from the wide area communication unit 31 to the smartphone 120.

In the smartphone 120 of the second embodiment shown in FIG. 11, the wireless operation program 1270 stored in the ROM of the control unit 127 is different from the wireless operation program 270 stored in the ROM of the control unit 27 in the first embodiment. Therefore, the function realized by the control unit 127 is also different from that of the control unit 27 of the first embodiment.

Specifically, the control unit 127 includes a connection setting unit 1272 instead of the operating device-side connection setting unit 272. The connection setting unit 1272 transmits the seat air conditioner identification information acquired by the acquisition unit 271 to the server 130. As a result, the server 130 executes S31 of FIG. 10 described above. Thereafter, when the server 130 executes S35, the BD address and the encryption key are transmitted to the smartphone 120. The BD address and the encryption key are received by the wide area communication unit 22. The connection setting unit 1272 acquires the BD address and the encryption key from the wide area communication unit 22. In the second embodiment, the process of acquiring the BD address and the encryption key from the wide area communication unit 22 corresponds to the connection setting process executed in S5.

In the second embodiment, the memory 32 of the server 130 stores, for each seat air conditioner 10, the seat air conditioner identification information, the encryption key stored in the connection setting storage unit 117 of the seat air conditioner 10, and the BD address of the seat air conditioner 10. Therefore, the smartphone 120 can perform pairing with the seat air conditioner 10 even when the smartphone 120 is in a position where the Bluetooth communication with the seat air conditioner 10 is not possible. Moreover, at the time of pairing, it is sufficient to access the server 130 to acquire the BD address and the encryption key, and it is not necessary to communicate with the seat air conditioner 10.

Although the embodiments of the present disclosure have been described above, the present disclosure is not limited to the above embodiments, and various modified examples described below are also included in the technical scope of the present disclosure. Furthermore, various modifications other than the following can be made without departing from the gist. In addition, while the various elements are shown in various combinations and configurations, which are exemplary, other combinations and configurations, including more, less or only a single element, are also within the spirit and scope of the present disclosure.

### First Modification

In the first embodiment, the seat air conditioner identification information is stored in the two-dimensional code 55, and by reading the two-dimensional code 55, the processing for pairing is started. Instead of this configuration, in a first modification, the memory 32 of the server 30 stores the seat air conditioner identification information regarding the plurality of seat air conditioners 10. The acquisition unit 271 of the smartphone 20 communicates with the server 30 via the wide area communication unit 22, and causes the display of the smartphone 20 to display a list of the plurality of seat air conditioners 10.

Then, when one seat air conditioner 10 is selected by the operation of the user 4, the server 30 may notify the smartphone 20 of the wide area communication address of the selected seat air conditioner 10. In this case, the acquisition unit 271 acquires the wide area communication address of the seat air conditioner 10, which is the seat air conditioner identification information, from the server 30. After acquiring this wide area communication address, the processing in FIG. 7 can be executed as in the first embodiment.

### Second Modification

In the second embodiment, the memory 32 stores, for each seat air conditioner 10, the seat air conditioner identification information and the encryption key stored in the connection setting storage unit 117 of the seat air conditioner 10 of the seat air conditioner 10. In a second modification, the two-dimensional code 55 printed on the boarding reservation ticket 50 stores the BD address and the encryption key of the seat air conditioner 10 determined by the bus number 51 of the bus 2, reserved seat number 53, and the like.

Therefore, according to the second modification, by capturing the two-dimensional code 55 with the camera 21 and reading the BD address and the encryption key from the two-dimensional code 55, the BD address and the encryption key of the seat air conditioner 10 can be acquired. In this case, the boarding ticket 50, which is a paper medium, is the storage medium. In the second modification, the smartphone 120 can perform pairing without connecting to the server 30.

### Third Modification

In the embodiments described above, the smartphone 20, 120 are shown as the wireless operation terminals. However, the wireless operation terminal is not limited to the smartphone 20, 120, and may be various terminals capable of short-range wireless communication.

Further, the operated device is not limited to the seat air conditioner 10, 110. For example, the operated device may be an in-vehicle device included in a vehicle electronic key system used in a share car. In this case, when the user 4 carrying the smartphone 20, 120 approaches the share car while pairing is completed in advance, the Bluetooth communication is automatically started. When this configuration is used as a trigger, the in-vehicle device notifies the surroundings of the start of the Bluetooth communication by blinking the side lights of the vehicle, ringing of the horn, or the like. The user 4 can easily recognize which vehicle is reserved. In this vehicle electronic key system, the smart phone 20, 120 can be used as the electronic key.

### Fourth Modification

In the above-described embodiments, the Bluetooth communication is described as the short-range wireless communication. However, the short-range wireless communication is not limited to the Bluetooth communication. For example, the short-range wireless communication may be Wi-Fi.

### Fifth Modification

Although the two-dimensional code 40, 55 are shown as the optical code. Alternatively, the optical code may be a one-dimensional code, that is, a bar code.

### Sixth Modification

In the above described embodiments, the position of the wide area communication unit 12 included in the seat air conditioner 10 is not particularly mentioned. The wide area communication unit 12 may be housed in one housing together with other elements included in the seat air conditioner 10. Alternatively, the wide area communication unit 12 may be provided outside the housing. When the wide area communication unit 12 is outside the housing, the connection with the element inside the housing may be a wired connection or a wireless connection. When the wide area communication unit 12 is outside the housing, the wide area communication unit 12 may be shared by a plurality of seat air conditioners 10.

The control portion and the method therefor which have been described in the present disclosure may be also realized by a dedicated computer which constitutes a processor programmed to execute one or more functions concretized by computer programs. Also, the device and the method therefor which have been described in the present disclosure may be also realized by a dedicated hardware logic circuit. Also, the device and the method therefor which have been described in the present disclosure may be also realized by one or more dedicated computers which are constituted by combinations of a processor for executing computer programs and one or more hardware logic circuits. Further, the computer program may store a computer-readable non-transitional tangible recording medium as an instruction to be executed by the computer.

What is claimed is:

1. A wireless operation system comprising:
a wireless operation terminal; and
an operated device operated by the wireless operation terminal, wherein:
the wireless operation terminal and the operated device perform short-range communication;
the wireless operation terminal includes
an acquisition unit configured to acquire operated device identification information which is information for identifying the operated device as a communication partner for the short-range communication from a medium apart from the operated device,
an operation terminal-side wide area communication unit connected to a wide area communication network and configured to perform wide area wireless communication, and
an operation terminal-side connection setting unit configured to (i) identify the operated device to be the communication partner based on the operated device identification information, (ii) cause the operation terminal-side wide area communication unit to transmit, to the operated device, operation terminal identification information which is information for the operated device to communicate with the wireless operation terminal, and (iii) perform transmission and reception of a signal for connection setting for the short-range communication with the operated device via the operation terminal-side wide area communication unit; and
the operated device includes
an operated device-side wide area communication unit connected to the wide area communication network and configured to perform the wide area wireless communication, and
an operated device-side connection setting unit configured to (i) receive the operation terminal identification information transmitted from the wireless operation terminal via the operated device-side wide area communication unit and (ii) perform transmission and reception of the signal for the connection setting for the short-range communication with the wireless operation terminal via the operated device-side wide area communication unit.

2. The wireless operation system according to claim 1, wherein:
the operated device identification information is represented by an optical code;
the wireless operation terminal further includes a camera; and
the acquisition unit acquires the operated device identification information by reading the optical code captured by the camera.

3. The wireless operation system according to claim 2, wherein:
the operated device is provided by an air conditioner attached to each seat in a bus that allows a passenger to reserve the seat; and
the optical code is printed on a boarding ticket.

4. The wireless operation system according to claim 3, wherein
the wireless operation terminal further includes
a reserved position determination unit configured to determine a position of the reserved seat based on an image of the boarding ticket captured by the camera, and
a guide control unit configured to guide the passenger who carries the wireless operation terminal to the position of the reserved seat.

5. The wireless operation system according to claim 1, further comprising
a server configured to communicate with the wireless operation terminal, wherein:
the medium is provided by a memory that is readable by the server and stores the operated device identification information for a plurality of operated target devices that includes the operated device; and
the acquisition unit acquires the operated device identification information from the memory based on communication with the server.

6. The wireless operation system according to claim 1, wherein
the wireless operation terminal further includes a remote operation unit configured to remotely operate the operated device via the operation terminal-side wide area communication unit after the connection setting for the short-range communication is completed.

7. A wireless operation system comprising:
a wireless operation terminal; and
an operated device operated by the wireless operation terminal, wherein:
the wireless operation terminal identifies the operated device as a communication partner for performing short-range communication with the operated device;
the operated device identifies the wireless operation terminal as a communication partner for performing the short-range communication with the wireless operation terminal;
the wireless operation terminal and the operated device share an encryption key and perform transmission and reception of a signal encrypted with the encryption key;
the wireless operation system further comprises a storage medium existing apart from the operated device and configured to store operated device identification information and the encryption key in association with each other, the operated device identification information identifies, as the communication partner, each of a plurality of operated target devices that includes the operated device, the encryption key is used when the operated device identified by the operated device identification information performs the short-range communication; and
the wireless operation terminal includes a connection setting unit configured to (i) acquire the encryption key corresponding to the operated device identification information from the storage medium by identifying the operated device identification information and (ii) perform connection setting for the short-range communication based on the acquired encryption key.

8. The wireless operation system according to claim 7, wherein:
the storage medium is provided by an electromagnetic storage medium readable by the server; and
the connection setting unit acquires the encryption key based on communication with the server.

9. The wireless operation system according to claim 7, wherein:
the storage medium includes an optical code storing the encryption key;
the wireless operation terminal further includes a camera; and
the connection setting unit acquires the encryption key by reading the optical code captured by the camera.

10. A non-transitory tangible computer readable storage medium comprising instructions executed by a processor of a wireless operation terminal configured to perform short-range communication with an operated device and operate the operated device, the instructions comprising:
acquiring operated device identification information which is information for identifying the operated device as a communication partner for the short-range communication from a medium apart from the operated device;
performing wide area wireless communication by connecting a wide area communication network;
identifying the operated device to be the communication partner based on the operated device identification information;
transmitting, to the operated device, operation terminal identification information which is information for the operated device to communicate with the wireless operation terminal; and
performing transmission and reception of a signal for connection setting for the short-range communication with the operated device.

11. A non-transitory tangible computer readable storage medium comprising instructions executed by a processor of a wireless operation terminal configured to perform short-range communication with an operated device and operate the operated device, the instructions comprising:
acquiring an encryption key corresponding to operated device identification information from a storage medium by identifying the operated device identification information; and
performing connection setting for short-range communication based on the acquired encryption key, wherein
the storage medium exists apart from the operated device and stores the operated device identification information and the encryption key in association with each other;
the operated device identification information identifies, as the communication partner, each of a plurality of operated target devices that includes the operated device; and
the encryption key is used when the operated device identified by the operated device identification information performs the short-range communication.
